(19) United States
(12) Patent Application Publication
(10) Pub. No.: US 2010/0156577 A1
(43) Pub. Date: Jun. 24, 2010

(54) MICRO-ELECTROMECHANICAL SYSTEM SWITCH

(75) Inventors: Xuefeng Wang, Schenectady, NY (US); Kuna Venkat Satya Rama Kishore, Bangalore (IN); Christopher Fred Keimel, Schenectady, NY (US); Glenn Scott Claydon, Wynantskill, NY (US); Kanakasabapathi Subramanian, Clifton Park, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/340,776

(22) Filed: Dec. 22, 2008

(51) Int. Cl. H01H 51/22

(52) U.S. Cl. 335/78; 200/181

(57) ABSTRACT

A micro electro-mechanical system switch is presented. The switch includes a base substrate having a support surface. An actuating surface having a notch and an electrical contact surface having an extension is provided. The extension is disposed within the notch. A beam is attached to the base substrate. The beam includes an actuatable free end that is configured to flex upon actuation and to make contact with at least a portion of the extension and carry current therethrough.

### BACKGROUND

The invention relates generally to a switch and in particular, to a micro-electromechanical system switch.

The use of micro-electromechanical system (MEMS) switches has been found to be advantageous over traditional solid-state switches. For example, MEMS switches have been found to have superior power efficiency, low insertion loss, and excellent electrical isolation.

MEMS switches are devices that use mechanical movement to achieve a short circuit (make) or an open circuit (break). The force required for the mechanical movement can be obtained using various types of actuation mechanisms such as electrostatic, magnetic, piezoelectric, or thermal actuation. Typically, electrostatically actuated switches have been demonstrated to have high reliability and wafer scale manufacturing techniques. Construction and design of such MEMS switches have been constantly improving.

Switch characteristics such as standoff voltage (between the contacts of the switch) and pull-in voltage (between the actuator and the contact) are considered for the design of MEMS switches. Typically, while trying to achieve higher standoff voltage presents a contradicting characteristic of a decreased pull-in voltage. Traditionally, increasing beam thickness and gap size increases standoff voltage. However, this increases the pull-in voltage as well and that is not desirable.

There exists a need for an improved MEMS switch that exhibits substantially high standoff voltage and at the same time substantially lower pull-in voltage without additional complexity in the switch design.

### BRIEF DESCRIPTION

Briefly, in one embodiment a micro electro-mechanical system switch is presented. The switch includes a base substrate having a support surface. An actuating surface having a notch and an electrical contact surface having an extension is provided. The extension is disposed within the notch. A beam is attached to the base substrate. The beam includes an actuatable free end that is configured to flex upon actuation and to make contact with at least a portion of the extension and carry current therethrough.

In one embodiment, a mechanical switch having a gate is presented. The gate defines a notch. The switch includes a drain having an extension, wherein the extension is disposed within the notch. A cantilever beam is fixed on a support post, the cantilever beam having a free moving end. The free moving end overlaps the extension to make a contact with at least a portion of the drain to form an electrical pathway.

In one embodiment, a micro electro-mechanical system switch is presented. The switch includes an actuator having a cavity and is configured to provide an electrostatic force. An electrode having an elongation is provided. The elongation includes a contact and is disposed within the cavity. A beam is fixed on a support post and has a free moving end, wherein the free moving end is configured to flex upon actuation to mate with the electrode and carry current therethrough.

In one embodiment, a mechanical switch is presented. The switch includes a cantilever beam fixed on a support post and comprising a moving part. The switch further includes an actuating region having a gap configured to provide an electrostatic force. An electrode region is disposed proximate to the actuating region, wherein the actuating region defines a notch and the electrode region comprises an extension surrounded by the notch on at lease two sides. The moving part is disposed proximate the actuating region and overlapping the extension to provide a standoff voltage to pull-in voltage ratio greater than about 1.5.

A method of increasing a ratio between standoff voltage and pull-in voltage in a switch is presented. The method includes providing an actuating surface defining a gap, providing an electrical contact surface having an extension, the extension that extends into the gap. The method further includes providing a beam suspended over the actuating surface and the electrical contact surface. The method further includes defining an overlap area comprising the actuating surface, the electrical contact surface, and the beam, and optimizing the overlap area to comprise a standoff voltage to pull-in voltage ratio greater than about 1.5.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of a MEMS switch in accordance with an aspect of the present technique;

FIG. 2 is a perspective view of the MEMS switch of FIG. 1 with a partial cut section;

FIG. 3 is a cross sectional view of MEMS switch in FIG. 1; and

FIG. 4 is a top view of various layers for fabrication of MEMS switch according to an aspect of the invention.

### DETAILED DESCRIPTION

A MEMS switch can control electrical, mechanical, or optical signal flow. MEMS switches typically provide lower losses, and higher isolation. Furthermore MEMS switches provide significant size reductions, lower power consumption and cost advantages as compared to solid-state switches. MEMS switches also provide advantages such as broadband operation (can operate over a wide frequency range). Such attributes of MEMS switches significantly increase their power handling capabilities. With low loss, low distortion and low power consumption, the MEMS switches may be suited for applications such as telecom applications, analog switching circuitry, and switching power supplies. MEMS switches are also ideally suited for applications where high performance electro-mechanical, reed relay and other single function switching technologies are currently employed.

MEMS switches may employ one or more actuation mechanisms, such as electrostatic, magnetic, piezoelectric, or thermal actuation. Compared to other actuation methods, electrostatic actuation provides fast actuation speed and moderate force. Electrostatic actuation requires ultra low power because typically power of the order of nano-joules are required for each switching event and no power is consumed when the switch is in the closed or open state. This approach is far better suited to power sensitive applications than the more power hungry magnetic switch activation approach that is traditionally used by mechanical relays in such applications. For example, conventional relays operate with high mechanical forces (contact and return) for short lifetimes (typically around one million cycles). MEMS switches operate with much lower forces for much longer lifetimes. Benefits of low contact forces are increased contact life. However, lower contact forces qualitatively change contact behavior, especially increasing sensitivity to surface morphology and contaminants and the corresponding low return forces make the switches susceptible to sticking.

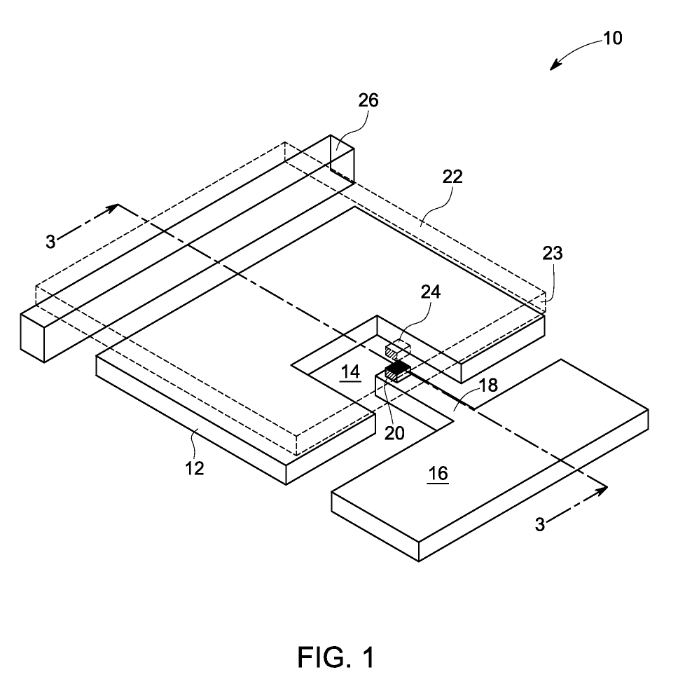

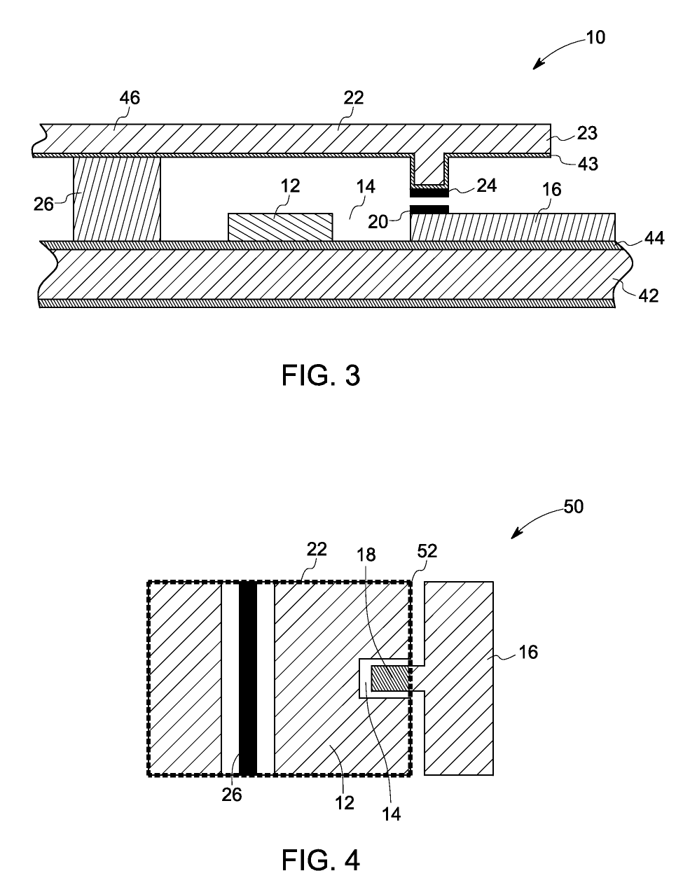

Referring first to FIG. 1, reference numeral 10 illustrates a MEMS switch built in accordance with an aspect of the invention. A base substrate (illustrated by reference numeral 42 in FIG. 3) having a support surface 26 (or a support post) is provided. An actuating surface 12 having a notch 14 is disposed proximate the base substrate. An electrical contact surface 16 having an extension 18 is disposed adjacent to the actuating surface 12. The extension 18 includes a contact bump 20, wherein the extension 18 is disposed within the notch 14. A beam 22 is attached to the base substrate via the support surface 26. The beam 22 includes a contact bump 24 and an actuatable free end 23 configured to flex upon actuation to make contact with at least a portion of the extension 18 and carry current therethrough.

During an operation of the MEMS switch 10, an electrical voltage is applied to the actuating surface 12 (also referred to as actuation). The actuating surface 12 provides an electrostatic force (upon actuation) that is proportional to the voltage applied to the actuating surface 12. In one embodiment, the electrostatic force exerts a force of attraction on the beam 22. The actuatable free end 23 is configured to flex upon actuation and form a contact with the electrical contact surface 16 via the contact bump 20 disposed on the extension 18. In one embodiment, the contact established between the extension 18 and the beam 22 facilitates flow of current and this state is often designated as “conduction” or “closed” state of the MEMS switch 10. In another embodiment, to change the state of the switch 10, the voltage applied to the actuating surface 12 is withdrawn, resulting in the “breaking” of the contact between the extension 18 and the beam 22 due to spring restoring force of the beam. This state is often referred to as “non-conduction” or “open” state of the MEMS switch 10.

Typically, MEMS switch defines a first voltage between the extension 18 and the beam 22. A standoff voltage is typically defined as a first threshold voltage wherein the extension 18 and the beam 22 come into contact when the first voltage exceeds the first threshold voltage. Similarly, MEMS switch defines a second voltage between the actuating surface 12 and the beam 22. A pull-in voltage is typically defined as a second threshold voltage of the actuating surface 12 wherein the extension 18 and the beam 22 come into contact when the second voltage exceeds the second threshold voltage. It may be appreciated that a better design of a MEMS switch requires a higher standoff voltage and a lower pull-in voltage. Simultaneously achieving a higher standoff voltage and reducing a pull-in voltage is contradictory. The embodiments of the present invention are cleverly articulated to overcome the contradiction by optimizing construction and disposition of the electrical contact surface 16, the actuating surface 12 and the beam 22.

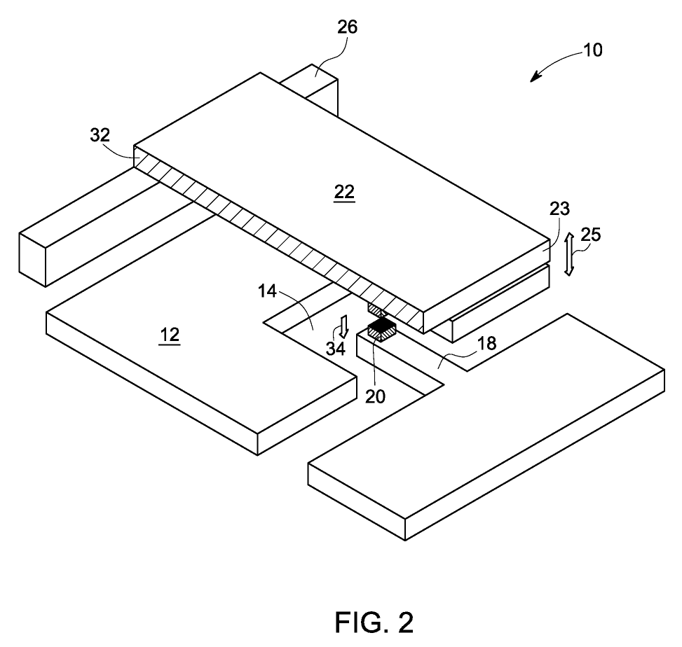

Turning now to FIG. 2, a partially cut-away section of the beam 22 is illustrated. In an exemplary embodiment, the MEMS switch 10 comprises a base substrate (not shown). The base substrate includes a support surface 26. An actuating surface 12 having a notch 14 and configured to provide an electrostatic force is provided. An electrical contact surface 16 having an extension 18 is disposed within the notch 14. A contact bump 20 is disposed on the extension 18. A beam 22 (illustrated with a partially cut section at 32) is fixed to the base substrate# via the support surface 26. The beam 22 that includes an actuatable free end 23 is configured to flex (25) upon actuation to make a contact with at least a portion of the extension 18 and carry current therethrough.

The beam 22 also referred to as a cantilever beam is fixed on a support post 26. The actuating surface 12 also referred to as an actuator (or a gate) is configured to provide an electrostatic force 34 upon actuation (applying voltage to the actuating surface). In one embodiment, the electrical contact surface 16 (or a drain) is disposed proximate to the beam 22 and configured to provide an electrical connection between itself and the cantilever beam 22. A free moving end 23 (or a moving part) of the beam 22 is configured to flex upon actuation to mate with the contact 20 on the extension 18 and carry current therethrough.

It may be noted that the actuating surface 12 includes a notch 14 as compared to a typical rectangular surface. The extension 18 is disposed within the notch 14, providing a reduced overlap between the electrical contact surface 16 and the beam 22. Furthermore, the notch 14 in the actuating surface 12 provides a reduced overlap with the beam 22. The overlap area is optimized to achieve a standoff voltage to pull-in voltage ratio (or a turn off ratio) greater than about 1.5. In another embodiment, the overlap area is optimized to achieve the turn off ratio of about 1.7 to about 5.

FIG. 3 is a cross sectional view of the MEMS switch in FIG. 1. In an exemplary embodiment, the MEMS switch 10 includes a base substrate 42. A silicon nitride layer 44 (insulating layer) is disposed on the base substrate 42. The support post 26, the actuating surface 12, and the electrical contact surface 16 are disposed on the insulating layer 44. The contact bump 20 is disposed at one end of the extension 18. In one embodiment, a beam 22 is fixed at one end 46 to the support post 26 and the free moving end 23 is projecting over the notch 14 and the extension 18. An insulating layer 43 is disposed between the beam 22 and the contact bump 24. The contact bump 24 aligned with the contact bump 20 on the electrical contact surface 16 to form a contact upon actuation during the “conduction” state of the MEMS switch 10.

In operation, to facilitate the movement of the cantilever beam 22, the actuating surface 12 is configured to generate electrostatic force is disposed proximate the beam 22 as illustrated. It may be noted that, the electrical contact surface 16 and the beam 22 are connected to external circuitry. In one embodiment, the MEMS switch 10 is configured to make or break an electrical connection between the electrical contact surface 16 and the beam 22. The base substrate 42 houses circuitry to render the MEMS switch 10 operational, such as for example but not limited to biasing circuitry, protection circuitry, and the like.

FIG. 4 is a top view of assembly layers according to an aspect of the invention. The MEMS switch having the cantilever beam 22 illustrated by the dotted line is fixed on the support post 26 as illustrated in the top view 50. The MEMS switch 50 indicated herein, includes a cantilever beam 22 (transparent illustration for better understanding of the disposition of various embodiments), and the actuating surface 12, and the electrical contact surface 16. As will be appreciated, the actuating surface 12 is designed to form the notch 14, resulting in a decreased actuating area extending below the beam 22. In one embodiment, such decreased actuating area results in a reduced pull-in voltage. Similarly, the overlap between the electrical contact surface 16 and the beam 22 is confined to the extension 18 and not along a beam width 52. Such reduced overlap increases the standoff voltage. In one embodiment, multiple extensions may be formed on the electrical contact surface with corresponding notches in the actuating surface along the width of the beam.

In an exemplary embodiment, a method of increasing a ratio between standoff voltage and pull-in voltage in a switch is presented. The method includes providing an actuating surface defining a gap, providing an electrical contact surface having an extension, the extension that extends into the gap. The method further includes providing a beam suspended over the actuating surface and the electrical contact surface. The method further includes defining an overlap area comprising the actuating surface, the electrical contact surface, and the beam, and optimizing the overlap area to comprise a standoff voltage to pull-in voltage ratio greater than about 1.5. In one embodiment, the overlap area is optimized to comprise a standoff voltage to pull-in voltage ratio of about 1.7 to about 5.

It may be appreciated that high turn off ratio is a significant factor in MEMS applications where high open state isolation voltage (or standoff voltage) and low actuation voltage (pull-in voltage) are desirable. Both standoff voltage and pull-in voltages generate electrostatic forces that are proportional to the overlap area of respective electrodes. Advantageously, by MEMS switch design discussed herein, arranging the location and adjusting overlap between the actuation surface and the electrical contact surface may achieve high turn off ratio. Traditionally, increasing beam thickness and distance between the actuator and the beam increases standoff voltage. However, this increases the pull-in voltage as well. Such contradicting effects may be overcome in the presently contemplated embodiments of the invention. Certain embodiments of the invention are designed to achieve substantially greater turn off ratio (ratio between the standoff voltage and pull-in voltage) greater than about 1.5 to about 5.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A micro electro-mechanical system switch comprising:
a base substrate having a support surface;
an actuating surface comprising a notch;
an electrical contact surface comprising an extension, wherein the extension is disposed within the notch; and
a beam attached to the base substrate, the beam having an actuatable free end configured to flex upon actuation to make contact with at least a portion of the extension and carry current therethrough.

2. The micro electro-mechanical system switch of claim 1, wherein the actuating surface provides an electrostatic force during actuation.

3. The micro electro-mechanical system switch of claim 2, wherein the electrostatic force is proportional to a voltage applied to the actuating surface.

4. The micro electro-mechanical system switch of claim 1, wherein the beam comes in contact with the electrical contact surface upon actuation.

5. The micro electro-mechanical system switch of claim 4, wherein the beam and the electrical contact surface are in contact during an operation of the mechanical switch.

6. The micro electro-mechanical system switch of claim 4, wherein the beam and the electrical contact surface are in isolation during an operation of the mechanical switch.

7. The micro electro-mechanical system switch of claim 1, wherein the extension comprises the notch surrounded on at least two sides.

8. The micro electro-mechanical system switch of claim 1, wherein the beam is suspended on the actuating surface and the extension.

9. The micro electro-mechanical system switch of claim 1 further comprising an overlap defining the actuatable free end, the extension, and the actuating surface, wherein the overlap provides a turn off ratio greater than about 1.5.

10. The micro electro-mechanical system switch of claim 9, wherein the overlap provides the turn off ratio of about 1.5 to about 5.

11. A mechanical switch comprising:
a gate defining a notch;
a drain comprising an extension, wherein the extension is disposed within the notch;
a cantilever beam fixed on a support post, the cantilever beam having a free moving end; and
the free moving end overlapping the extension to make a contact with at least a portion of the drain to form an electrical pathway.

12. A micro electro-mechanical system switch comprising:
an actuator comprising a cavity and configured to provide an electrostatic force;
an electrode comprising an elongation, the elongation comprising a contact and disposed within the cavity; and
a beam fixed on a support post and comprising a free moving end, wherein the free moving end is configured to flex upon actuation to mate with the electrode and carry current therethrough.

13. The micro electro-mechanical system switch of claim 12, wherein the electrode is further configured to conduct current from the beam during an operation of the switch.

14. The micro electro-mechanical system switch of claim 12 further comprising an overlap defining the contact, the free moving end, and the electrode.

15. The micro electro-mechanical system switch of claim 14, wherein the overlap is configured to provide a turn off ratio of greater than about 1.5.

16. The micro electro-mechanical system switch of claim 15, wherein the overlap is configured to provide the turn off ratio of about 1.7 to about 5.

17. A mechanical switch comprising:
a cantilever beam fixed on a support post and comprising a moving part;
an actuating region comprising a gap configured to provide an electrostatic force; and
an electrode region disposed proximate to the actuating region,
wherein the actuating region defines a notch and the electrode region comprises an extension surrounded by the notch on at lease two sides;
wherein the moving part is disposed proximate the actuating region and overlapping the extension to provide a standoff voltage to pull-in voltage ratio greater than about 1.5.

18. The switch of claim 17, wherein the cantilever beam flexes upon actuation to form an electrical connection with the electrode.

19. The switch of claim 17, wherein the moving part comprises a first electrical contact.

20. The switch of claim 17, wherein the extension comprises a second electrical contact.

21. The switch of claim 17, wherein the electrostatic force is configured to provide a contact force between the first electrical contact and the second electrical contact during an operation of the switch.

22. The switch of claim 17, wherein the extension is configured to have an optimized area of overlap with the moving part.

23. The switch of claim 17 further configured to provide a standoff voltage to pull-in voltage ratio of about 1.7 to about 5.

24. A method of increasing a ratio between standoff voltage and pull-in voltage in a switch, the method comprising:
providing an actuating surface defining a gap;
providing an electrical contact surface comprising an extension, the extension that extends into the gap;
providing a beam suspended over the actuating surface and the electrical contact surface;
defining an overlap area comprising the actuating surface, the electrical contact surface, and the beam; and
optimizing the overlap area to comprise a standoff voltage to pull-in voltage ratio greater than about 1.5.

25. The switch of claim 24, wherein overlap area comprise the standoff voltage to pull-in voltage ratio of about 1.7 to about 5.
